(19) United States
(12) Patent Application Publication
(10) Pub. No.: US 2019/0210714 A1
(43) Pub. Date: Jul. 11, 2019

(54) AERODYNAMIC ELEMENT OF AN AIRCRAFT, COMPRISING A SET OF PROTRUDING ELEMENTS

(71) Applicant: Airbus Operations S.A.S., Toulouse (FR)

(72) Inventor: Mathias Farouz-Fouquet, Toulouse (FR)

(73) Assignee: Airbus Operations S.A.S., Toulouse (FR)

(21) Appl. No.: 16/239,730

(22) Filed: Jan. 4, 2019

(30) Foreign Application Priority Data
Jan. 8, 2018 (FR) 18 50114

(51) Int. Cl. B64C 21/10

(52) U.S. Cl. CPC B64C 21/10; F15D 1/0035; B64C 2230/26

(57) ABSTRACT

An aerodynamic element is provided with at least one set of protruding elements, each of the protruding elements is produced in the form of an elongate and profiled rib projecting from a surface of the aerodynamic element. The protruding elements are arranged at the surface of the aerodynamic element, one beside the other, being oriented substantially parallel to one another so that each of them generates a vortex, the set of vortices thus generated making it possible to reduce crossflow instability.

### FIELD OF THE INVENTION

The present invention relates to an aerodynamic element of an aircraft, provided with a set of protruding elements.

Although not exclusively, the aerodynamic element may correspond to a wing of the aircraft, for example a transport aeroplane. It may also relate to another aerodynamic element (or surface) (empennage, flap, etc.) of the aircraft, as specified hereinbelow.

### BACKGROUND OF THE INVENTION

In the case notably of an aircraft wing referred to as a laminar-flow wing, which is a wing that is able to maintain a laminar flow over a significant distance, it is known that it is generally not possible to increase the sweep of the wing beyond 20° (at the leading edge of the wing).

This is because a wing sweep of more than 20° at the leading edge creates crossflow instability, particularly in the case of laminar-flow wings in which the pressure gradient is kept low, which is to say below or equal to 0, over a long portion of the chord of the wing. This crossflow instability is the main limitation on increasing the sweep of the wing. This phenomenon is characterized by the appearance of a crossflow along the span, accompanied by vortices which travel along the span of the wing. This prevents a laminar flow from being sustained. Now, increasing the sweep would make it possible to increase the speed of the aircraft in cruising flight without increasing the drag and fuel consumption.

### BRIEF SUMMARY OF THE INVENTION

An aspect of the present invention may improve the conditions of flow over an aerodynamic element of an aircraft such as a wing, in order notably, particularly in the case of a laminar-flow type of wing, to prevent the onset of crossflow instability even if the wing is highly swept.

According to an embodiment of the invention, the aerodynamic element is provided with at least one set of protruding elements, each of the protruding elements is produced in the form of an elongate and profiled rib projecting from a surface of the aerodynamic element, and the protruding elements of the set are arranged at the surface of the aerodynamic element, one beside the other, being oriented substantially parallel to one another.

Thus, each of the protruding elements, because of its particular shape and its particular orientation, as specified hereinabove, generates one, and only one, vortex. This vortex combines with a vortex (located at the same point) of a crossflow instability in order to lessen it. As a result, thanks to the combined effect of all these protruding elements, the crossflow instability is reduced and the conditions of flow over the aerodynamic element are improved.

In a first embodiment, at least some of the protruding elements are longitudinally curved.

Furthermore, in a second embodiment, at least some of the protruding elements are longitudinally rectilinear.

Furthermore, advantageously, at least some (but preferably all) of the protruding elements are oriented in a direction inclined by a given angle with respect to a direction of a crossflow flowing along the aerodynamic element.

Furthermore, advantageously, the aerodynamic element comprises a leading edge and a first set of protruding elements, the first set of protruding elements being arranged along the leading edge on a first face of the aerodynamic element ending at the leading edge, the protruding elements of the first set being oriented transversely to the leading edge.

In addition, advantageously, the aerodynamic element comprises a second set of protruding elements, the second set of protruding elements being arranged along the leading edge on a second face of the aerodynamic element ending at the leading edge, the protruding elements of the second set being oriented transversely to the leading edge.

Moreover, in a preferred embodiment, each one of the protruding elements has at least one of the following characteristics (or dimensions):
a length comprised between 1 millimetre and 30 millimetres;
a thickness less than or equal to 0.5 millimetre; and
a height comprised between 5 and 50 micrometres.

In addition, advantageously, the protruding elements are spaced apart by a distance comprised between 2 and 8 millimetres, and preferably equal to 5 millimetres.

In the context of the present invention, the aerodynamic element which is provided with the protruding elements may correspond to at least part of one of the following elements of the aircraft:
a wing;
a flap;
a vertical empennage;
a horizontal empennage;
part of a fuselage;
a nacelle of an engine.

The present invention also relates to an aircraft, particularly a transport aeroplane, which comprises at least one aerodynamic element provided with protruding elements like the one described hereinabove.

### BRIEF DESCRIPTION OF THE DRAWINGS

The attached figures will make it easy to understand how the invention may be carried out. In these figures, identical references refer to similar elements. More particularly:

FIG. 1 is a schematic perspective view of an aircraft to which the present invention is applied;

FIGS. 2 and 3 are schematic views, respectively in perspective and in front view, of a leading edge of part of a wing of an aircraft, which is provided with sets of protruding elements;

FIGS. 4 and 5 schematically illustrate perspective views of two different embodiments of a protruding element respectively;

FIGS. 6 and 7 schematically show air flows generated around a protruding element;

FIG. 8 is a schematic perspective view of a leading edge of part of a wing of an aircraft, provided with sets of protruding elements, in which view the air flows generated have been indicated; and

FIG. 9 is a diagram showing how, on the one hand, vortices generated by protruding elements and, on the other hand, vortices from crossflow instability combine to reduce the crossflow instability.

### DETAILED DESCRIPTION

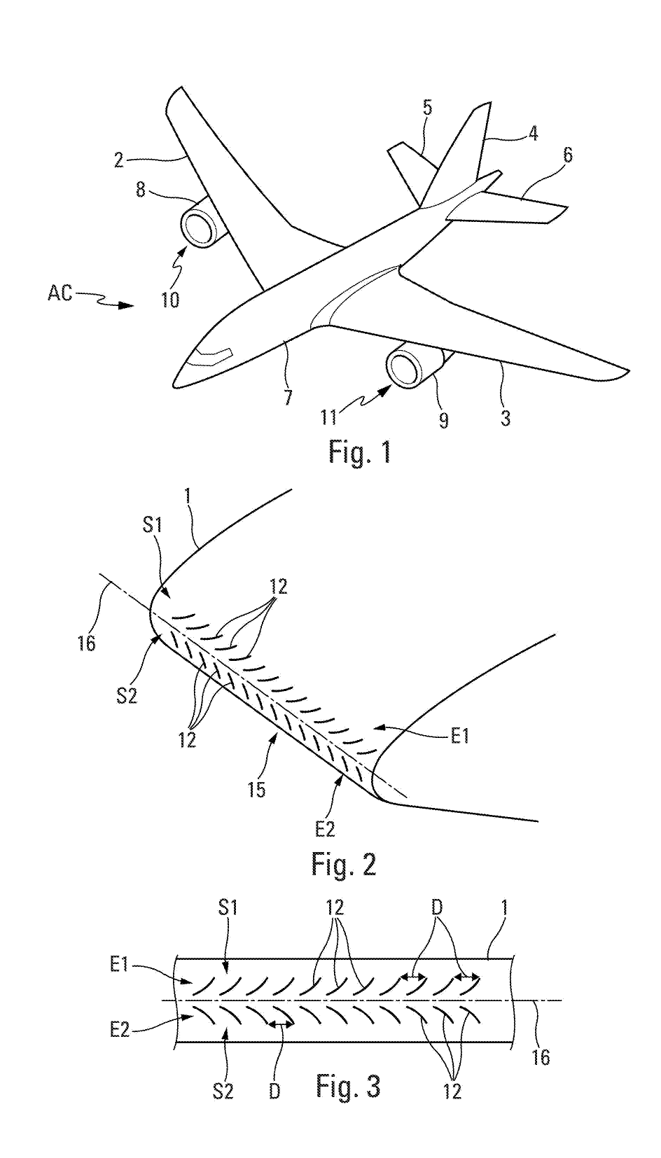

FIG. 1 schematically shows an aircraft AC, particularly a transport aeroplane, which is provided with at least one aerodynamic element (not specifically shown) like the one depicted in FIG. 2.

In the context of the present invention, the aerodynamic element 1 (FIG. 2) may correspond to one of the following elements (or surfaces) or to part of one of the following elements (or surfaces) of the aircraft AC which are depicted in FIG. 1:
a wing 2, 3;
a vertical empennage 4;
a horizontal empennage 5, 6;
part of the fuselage 7;
a nacelle 8, 9 of an engine 10, 11; or
a flap (not specifically depicted).

By way of (nonlimiting) illustration, the aerodynamic element 1 considered in the remainder of the description corresponds to a part (or section) of one of the wings 2, 3 of the aircraft AC.

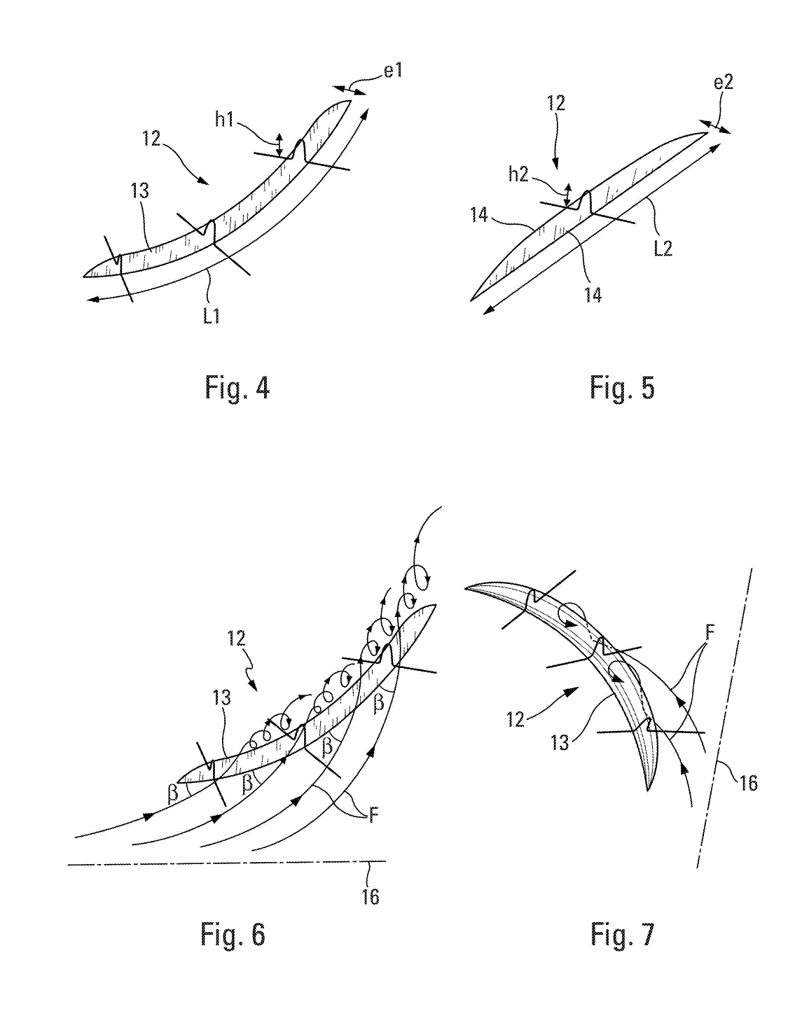

According to an embodiment of the invention, this aerodynamic element 1 is provided, as depicted notably in FIGS. 2 and 3, with at least one set E1, E2 of protruding elements 12. Each of the protruding elements 12 is produced in the form of an elongate (in a direction referred to as longitudinal) and profiled rib 13, 14 (FIGS. 4 and 5) and is arranged in such a way as to project with respect to a surface S1, S2 of the aerodynamic element 1. In addition, the protruding elements 12 of the set E1, E2 are arranged at the surface S1, S2 of the aerodynamic element 1; one beside the other, being oriented substantially parallel to one another.

Thus, each of the protruding (or prominent) elements 12, on account of its raised particular shape and its orientation, as specified hereinbelow, generates a vortex which will contribute to reducing the crossflow instability on the aerodynamic element 1.

The protruding elements 12 may be produced in various ways.

In a first embodiment, all of the protruding elements 12 are in each instance produced in the form of a profiled rib 13. As depicted in FIG. 4, this rib 13 is longitudinally curved (which means to say curved in its longitudinal direction) in the plane of the surface of the aerodynamic element on which it is arranged.

Furthermore, in a second embodiment, all of the protruding elements 12 are in each instance produced in the form of a profiled rib 14. As depicted in FIG. 5, this rib 14 is longitudinally rectilinear (which means to say rectilinear in its longitudinal direction) in the plane of the surface of the aerodynamic element on which it is arranged.

Furthermore, in a third embodiment, the aerodynamic element 1 may comprise protruding elements 12 produced in the form of the rib 13 over at least a first part (or section) and protruding elements 12 produced in the form of the rib 14 over at least a second part (or section).

In one preferred embodiment, each one of the protruding elements 12 has at least one and preferably all of the following characteristics (or dimensions), indicated in FIGS. 4 and 5:
a length L1, L2 comprised between 1 millimetre and 30 millimetres;
a thickness e1, e2 less than or equal to 0.5 millimetre; and
a height h1, h2 comprised between 5 and 50 micrometres, and preferably substantially equal to 15 micrometres.

Each of the protruding elements 12 is characterized by an aspect ratio greater than 1.

The orientation of the protruding elements 12 on the aerodynamic element 1 is defined directly as a function of the direction of a flow of air along the aerodynamic element 1, as specified hereinbelow.

Moreover, in the example depicted in FIGS. 2 and 3, the aerodynamic element 1, notably a wing, comprises a leading edge 15 with an attachment line 16 and two surfaces S1 and S2, one on each side of this leading edge 15.

In this example, the aerodynamic element 1 is provided with a first set E1 of protruding elements 12. The set E1 of protruding elements 12 is arranged along the leading edge 15 on the surface (or face) S1 of the aerodynamic element 1, which ends at the leading edge 15 from the top. The protruding elements 12 of the set E1 are oriented transversely to the leading edge 15, as specified hereinbelow.

In addition, in this example of FIGS. 2 and 3, the aerodynamic element 1 also comprises a second set E2 of protruding elements 12. This set E2 of protruding elements 12 is arranged along the leading edge 15 on the surface (or face) S2 of the aerodynamic element 1 which ends at the leading edge 15 from the bottom. The protruding elements 12 of the set E2 are also oriented transversely to the leading edge 15.

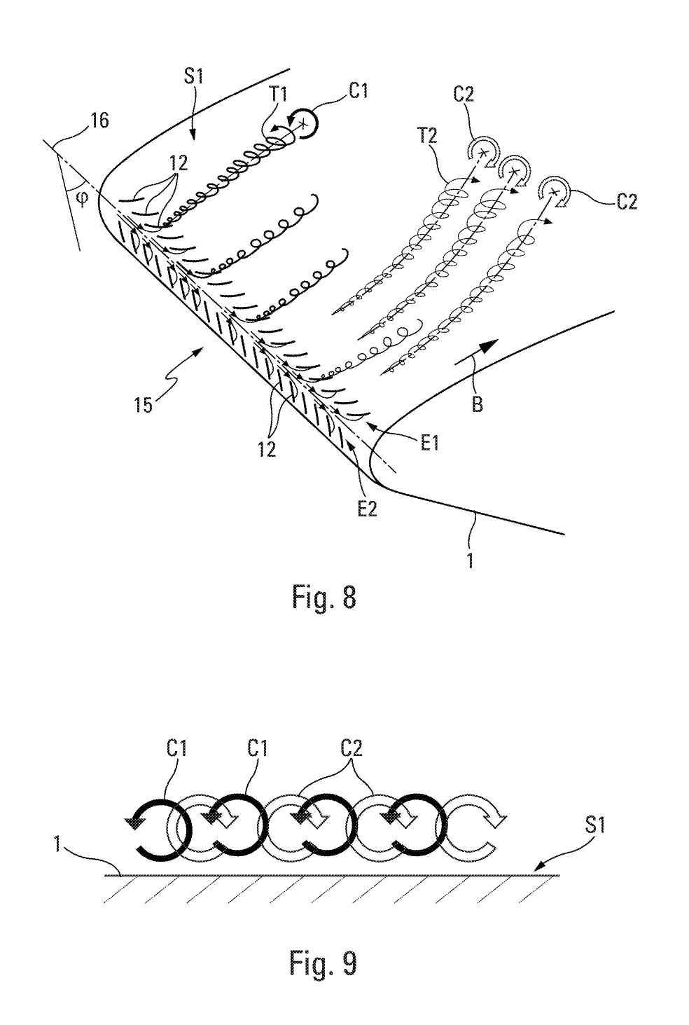

The protruding elements 12 are arranged downstream of the attachment line 16 (in the direction indicated by an arrow B in FIG. 8) at a distance representing approximately 1% of the chord of the aerodynamic element 1 that forms a wing, and are spaced apart (along the attachment line 16) by a distance D (FIG. 3) comprised between 2 and 8 millimetres and preferably equal to 5 millimetres.

The orientation of the protruding elements 12 is therefore determined as a direct function of the direction of the flow of air over the aerodynamic element 1.

The flow arriving from the attachment line 16 and in the vicinity thereof, describes a curved path, as illustrated by arrows F in FIGS. 6 and 7.

The protruding elements 12 are oriented with an inclination by a given angle β with respect to the direction of the crossflow, illustrated by the arrows F in FIGS. 6 and 7, flowing along the aerodynamic element 1 substantially transversely to the attachment line 16 in the direction indicated by the arrow B in FIG. 8.

The orientation and layout of the protruding elements 12, of which the longitudinal direction locally forms an angle β with the flow F, are such that one, and only one, vortex T1 is created downstream (in relation to the direction indicated by the arrow B) of each protruding element 12, as depicted in FIG. 8. Because this vortex T1 is singular (just one vortex T1 per protruding element 12), it cannot become turbulent by merging with a second vortex.

In addition, each protruding element 12 is oriented in such a way that the vortex T1 generated by this protruding element 12 rotates in a direction C1 which is opposite to the direction C2 (of rotation) of a vortex T2 of the crossflow instability. Thus, locally, downstream of each protruding element 12, the two vortices T1 and T2 combine and reduce (or cancel) one another.

In other words, the vortices T1 generated by the protruding elements 12 lessen the vortices T2 of the crossflow instability, as illustrated in FIG. 9.

This crossflow instability which has negative effects on the flow over the aerodynamic element 1, notably by limiting the laminar flow, is therefore reduced (if not to say cancelled) by the protruding elements 12. Thus, where appropriate, the laminar boundary layer on the aerodynamic element 1 is maintained.

In the example of an aerodynamic element 1 with a leading edge 15 representing wing 2, 3, the orientation of the protruding elements 12 with respect to the flow F around the radius tip of the leading edge 15 is such that each individual vortex T1 (per protruding element 12) rotates in the clockwise direction on a right-hand wing 2, and in the counterclockwise direction on a left-hand wing 3.

The protruding elements 12 as described hereinabove are not vortex generators. Specifically, a vortex generator in the usual way takes kinetic energy from the flow above the boundary layer of the surface on which it is arranged, and pulls this energy down into the boundary layer to give it energy and prevent air flow detachment. The protruding elements 12 that generate the individual vortices T1, described hereinabove, have a completely different action and a different objective. The protruding elements 12 remain low in height in the laminar boundary layer and do not pull in air from the flow outside the boundary layer.

The set E1, E2 of protruding elements 12, as described hereinabove, offers numerous advantages. In particular:
it makes it possible to maintain a laminar flow over a wing which has a leading edge 15 sweep φ (FIG. 8) greater than 20°;
it allows the aircraft higher cruising speeds;
it makes it possible to provide laminar flows over the wings of long-haul aeroplanes;
it makes it possible to reduce drag even at Mach numbers of above 0.77 and thus makes it possible to reduce fuel consumption;
it can be tested very simply, using numerical methods for studying fluid dynamics of the CFD (Computational Fluid Dynamics) types and/or using wind-tunnel and/or flight testing;
it is of a passive type and requires no energy, and neither does it require any mechanical device;
it can easily be incorporated into a moulded or possibly printed leading edge; and
it generates practically no additional mass.

The protruding elements 12 as described hereinabove, may therefore notably be mounted:
on the wings 2, 3 of the aircraft AC (FIG. 1);
on flaps of the aircraft AC;
on the vertical empennage 4 of the aircraft AC;
on the horizontal empennage 5, 6 of the aircraft AC;
on the fuselage 7 of the aircraft AC; or
on the nacelle 8, 9 of an engine 10, 11 of the aircraft AC.

These protruding elements 12 may be manufactured in various ways.

According to a first method of manufacture, which is simple, the protruding elements are moulded directly into the aerodynamic element 1, for example into the leading edge of a wing.

According to a second method of manufacture, the protruding elements are engraved by discharge machining into the die of the tooling.

Furthermore, according to a third method of manufacture, cylindrical added components (or inserts) are added to the aerodynamic element 1. These added components (or inserts) lie flush with the surface of the aerodynamic element. The shape of the protruding elements is present in relief on the exterior surface of these added components.

In an alternative form of embodiment, the protruding elements are attached by adhesive bonding to a strip applied to the aerodynamic element, which means to say that the adhesive strip (covering a significant proportion of the leading edge of the aerodynamic element) is printed with the shapes of the protruding elements.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aerodynamic element of an aircraft comprises:
a leading edge; and
a first set of protruding elements arranged along the leading edge on a first face of the aerodynamic element ending at the leading edge, the protruding elements of the first set being oriented transversely to the leading edge, each of the protruding elements is produced in the form of an elongate and profiled rib projecting from a surface of the aerodynamic element,
wherein said protruding elements of the first set are arranged at the surface of the aerodynamic element, one beside the other, being oriented substantially parallel to one another.

2. The aerodynamic element according to claim 1, wherein at least some of the protruding elements are longitudinally curved.

3. The aerodynamic element according to claim 1, wherein at least some of the protruding elements are longitudinally rectilinear.

4. The aerodynamic element according to claim 1, wherein at least some of the protruding elements are oriented in a direction inclined by a given angle with respect to a direction of a crossflow flowing along the aerodynamic element.

5. The aerodynamic element according to claim 1, further comprising a second set of protruding elements, the second set of protruding elements being arranged along the leading edge on a second face of the aerodynamic element ending at the leading edge, the protruding elements of the second set being oriented transversely to the leading edge.

6. The aerodynamic element according to claim 1, wherein each one of the protruding elements has at least one of the following characteristics:
a length between 1 millimetre and 30 millimetres;
a thickness less than or equal to 0.5 millimetre; and
a height between 5 and 50 micrometres.

7. The aerodynamic element according to claim 1, wherein the protruding elements are spaced apart by a distance between 2 and 8 millimetres.

8. The aerodynamic element according to claim 1, wherein the aerodynamic element corresponds to at least part of one of the following elements of the aircraft:
a wing;
a flap;
a vertical empennage;
a horizontal empennage;
part of a fuselage;
a nacelle of an engine.

9. An aircraft comprising at least one aerodynamic element according to claim 1.
